(19) United States
(12) Patent Application Publication
(10) Pub. No.: US 2010/0314388 A1
(43) Pub. Date: Dec. 16, 2010

(54) Dual combination wine bottle

(76) Inventor: Grady Gibson, Ft. Thomas, KY (US)

Correspondence Address: R. Christian Macke, 40 East 10th Street, Newport, KY, 41071, US

(21) Appl. No.: 12/456,147

(22) Filed: Jun. 12, 2009

(51) Int. Cl. B65D 6/00; B67B 3/00

(52) U.S. Cl. 220/4.28; 53/484

(57) ABSTRACT

A combination wine bottle having multiple independently accessible receptacles for packaging wine. The combination wine bottle visually and spatially emulates a standard 750 ml wine bottle to allow existing transportation and storage devices to be used while providing a package that allows a portion of the wine to be maintained fresh or packaging to two different wines together.

### FIELD OF THE INVENTION

This invention relates to a combination wine bottle that emulates a single wine bottle in which wine is retained in two separate receptacles.

### BACKGROUND OF THE INVENTION

The world wide consumption of wine over many centuries has produced innumerable innovations in the manufacturing, packaging and marketing of wine around the world. Surprisingly, however, most wine marketed by producers and consumed by consumers is still sold in the same familiar bottles in which it has been sold for many years. Typically, this bottle is 750 ml and is formed from glass.

Thus, while most beverage manufacturers have moved to plastic bottling or aluminum cans, such as soft drinks and beer, for example, the packaging of wine has remained virtually unchanged. There are several explanations, other than a general resistance to change by wine manufacturers.

Compared to soft drinks, beer and liquor, wine, particularly fine wine, is perceived differently and has a different presence in the marketplace and with its consumers, particularly connoisseurs and collectors who may store fine wines for years before consuming it. Particularly in those instances, after purchasing a wine a consumer will purchase a bottle of wine and store it, allowing it to age before consuming it. This creates several disadvantages with the existing bottling and storage arrangement. First, storage of wine virtually mandates that the size and shape of the bottle in which it is packaged so that it will fit into existing wine racks and storage facilities. For casual wine purchasers, who may keep 4-5 bottles of wine in the house, to the connoisseurs and corporate wine purchasers such as restaurants and drinking establishments which may keep hundreds or thousands of bottles of wine on hand, they all have a wine storage facility in which the wine bottles are maintained. Typically this is a system of shelves or racks in which the bottles of wine can be displayed and organized. These wine storage facilities are generally designed to accept the most commonly sized and shaped wine bottle, the 750 ml bottle that is typical. This is generally true for storage facilities whether they are dusty stand alone wine racks or precision temperature controlled refrigeration cabinets.

In addition to the storage facilities at the homes or businesses of wine consumers, there are also provisions for handling bottles of wine in the manufacturing plant and vineyards and during transport, distribution, marketing and display. All of those steps and stages have become acclimated to the bottle of the familiar shape that holds 750 ml.

Any development in the packaging of wine must take into account this 750 ml size and shape to allow the wine storage facilities to be used with any new product. Any wine packaging that does not do so risks almost certain failure because it would complicate transportation, distribution, marketing, display and storage.

In addition to complicating the transportation, distribution, marketing and display of wine, deviating from the typical 750 ml bottle will be a difficult adjustment to make in manufacturing. The automatic handling, ordering, filling and sealing machines in the packaging of wine all are premised on the 750 ml bottle.

To provide a wine packaging concept that provides multiple storage receptacles within a bottle of wine, which is the primary objective of the present invention, it will be necessary to modify the existing fill and seal portions of existing wine packaging facilities. Typically, the bottling of wine includes a single fill in which a certain kind or class of wine is charged into the storage receptacle, i.e. the 750 ml bottle, air is then evacuated and the bottle is sealed. Evacuation is important to keep air or gases from reacting with the wine and to keep it fresh for whenever it is finally consumed, whether in a week or a decade.

There are several disadvantages to the packaging of wine in a single 750 receptacle, however. First, once the bottle of wine is opened, either the entire 750 ml contained therein must be consumed or it will spoil. Even if the leftover wine is resealed and refrigerated, it will still react with the air and gases to which it is exposed and will lose its freshness. It may even take on the flavor or aroma of other things stored in the refrigerator along with the wine. For those reasons, wine that is not consumed during a first sitting after the wine is open will usually be discarded. It is a significant disadvantage with the present status of wine packaging that it is not practical to consume only a portion of a 750 ml bottle of wine and save the rest.

In addition, the single receptacle, single fill and single closure steps of the prior art wine packaging process do not allow any possibility of packaging two disparate kinds, classes or styles of wine together in a single 750 ml bottle. If, for example, a consumer thinks that one bottle may not be quite enough, or if there will be more than one person drinking wine but they choose different wines (e.g. one chooses red, one chooses white) the consumer will be forced to buy two separate 750 ml bottles. And, again, because saving leftover wine is not a common or desirable practice, the entire bottles must be consumed at the first sitting.

In light of these disadvantages, it would be beneficial to manufacture and market wine in a package that is the same or similar to the existing packaging, i.e. the 750 ml bottle, but which offers advantages not realized in existing packaging. This will allow manufacturing, distribution, marketing and storage of wine in a new package while still employing existing transportation and storage facilities. The new packaging should be provided, however, with accommodations for consumers who will not drink an entire bottle of wine in a single sitting. Also, it should be able to accommodate consumers who wish to drink different kinds of wine without requiring a purchase of two full 750 ml bottles.

To accomplish the foregoing, a package is described in more detail herein comprising a multiple receptacle bottle on which are multiple independent closure devices so that it is only necessary to expose a portion of the wine contained in a single receptacle, and not necessarily the entire 750 ml stored therein.

The improved package of the present invention will accommodate two independently sealed and accessible receptacles of the same wine, or they may be used for two disparate kinds or classes of wines. This will initially complicate the manufacturing and bottling process but the end result will be a product that allows consumers to effectively purchase wine in smaller amounts without impacting the existing transportation, distribution and marketing of wine or, significantly, the storage facilities employed by consumers.

### OBJECTS OF THE INVENTION

It is an object of the present invention to provide a combination wine bottle that has multiple storage receptacles with independent access means to each receptacle.

It is another object of the present invention to provide a combination wine bottle allowing a reduced portion of wine to be consumed without exposing the entire contents to air or gases or otherwise subjecting the remainder in the bottle to spoilage.

It is yet another object of the present invention to provide a combination wine bottle wherein multiple kinds of wine can be packaged and stored in a single bottle that emulates the size and shape of a typical wine bottle.

It is a further object of the present invention to provide a combination wine bottle having multiple independent and separable receptacles and means for locking the separable receptacles together to emulate an existing typical bottle of wine.

It is a further object of the present invention to provide a combination wine bottle wherein at least two independent receptacles contain wine and wherein each may be fully consumed without compromising the wine in the other receptacle.

It is yet another object of the present invention to provide a combination wine bottle having multiple storage receptacles that does not affect the existing methods of transporting, distributing, marketing or storing wine by manufacturers or consumers.

It is another object of the present invention to provide a method for marketing and distributing wine in a combination bottle wherein smaller portions of the wine may be accessed than a full bottle without subjecting the entire contents to spoilage.

It is yet another object of the present invention to provide a method for marketing and distributing wine in a combination bottle with multiple receptacles wherein multiple kinds of wine can be packaged, transported and sold together without requiring the purchase by consumers of full bottles of wine and without modifying the storage facilities for the wine.

These and other objects and advantages of the present invention will be apparent from a review of the following specification and accompanying drawings.

### SUMMARY OF THE INVENTION

The present invention comprises a combination bottle having multiple separate compartments. A first receptacle and a sleeve affixed to the first receptacle receive a second receptacle that remains separable from the first receptacle and sleeve. An independent closure means is provided on both the first receptacle and the second receptacle. In addition, a means for locking the second receptacle in the sleeve is provided by a raised shoulder formed on said second receptacle correspondingly engaging a tapered mouth formed in said sleeve.

In an important feature of the present invention, the second receptacle retained in the sleeve and affixed to the first receptacle is the approximate size and shape and emulates a typical 750 ml wine bottle.

In another feature of the present invention, the first receptacle, the second receptacle and the sleeve are all formed from resilient, deformable plastic.

The present invention also discloses a method for packaging wine that comprises the first step of providing a combination bottle emulating a single bottle of wine in size and shape, with the combination bottle having multiple receptacles, each of the receptacles having independent means for closure. Next, the receptacles are alternatively filled and sealed either the same wine or different wines.

### BRIEF DESCRIPTION OF THE DRAWINGS

FIG. 1 is an illustration of the prior art wine bottle emulated by the present invention.

FIG. 2 is a frontal illustration of the combination bottle of the present invention having dual cylindrical necks.

FIG. 2A is a top view of the combination bottle of the present invention having dual cylindrical necks.

FIG. 3 is a frontal illustration of the combination bottle of the present invention having dual semicircular necks.

FIG. 3A is a top view of the combination bottle of the present invention having dual semicircular necks.

FIG. 4 is an illustration of the first receptacle and sleeve affixed thereto of the present invention for the dual cylindrical necks embodiment.

FIG. 4A is an illustration of the second receptacle of the present invention for the dual cylindrical necks embodiment.

FIG. 5 is an illustration of the first receptacle and sleeve affixed thereto of the present invention for the dual semicircular necks embodiment.

FIG. 5A is an illustration of the second receptacle of the present invention for the dual semicircular necks embodiment.

FIG. 6 is an illustration of the construction of the present invention having three pieces.

FIG. 7 is a top view of the cup in the three piece construction of the present invention.

FIG. 8 is the fully assembled wine bottle of the present invention constructed from three pieces.

### DETAILED DESCRIPTION OF THE INVENTION

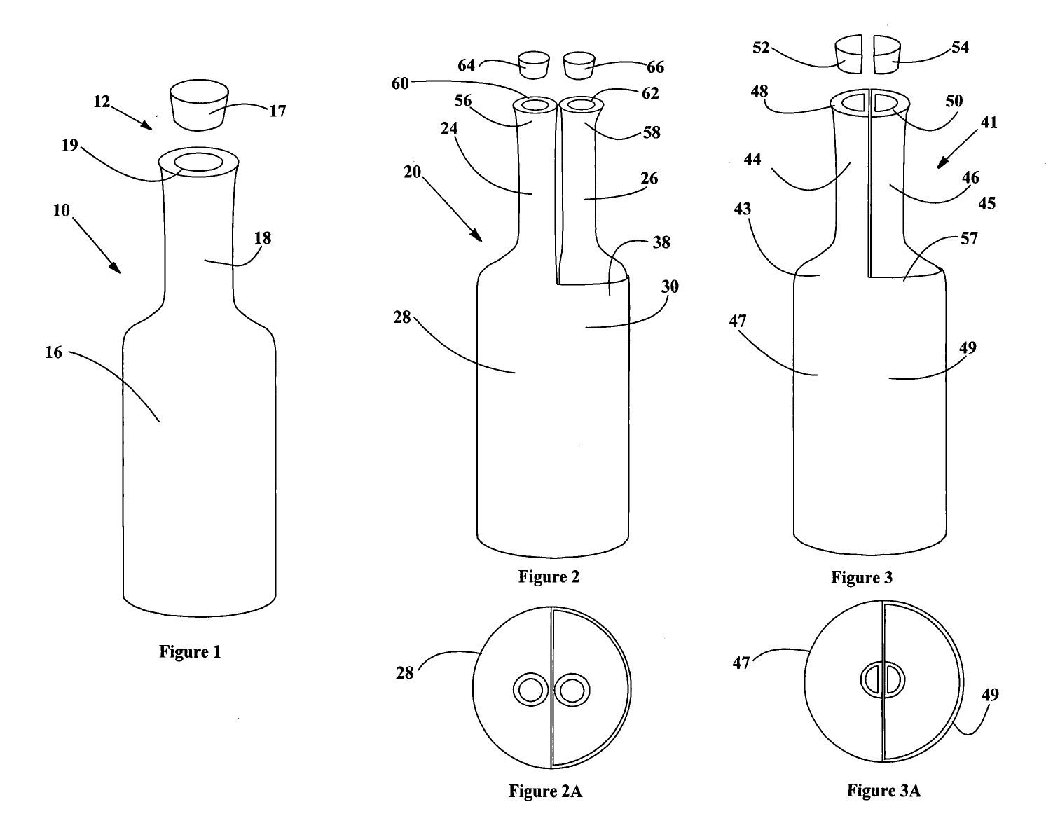

A typical prior art wine bottle is depicted generally as bottle 10 in FIG. 1. This prior art wine bottle 10 is a receptacle for the retail sale of 750 milliliters of wine wherein the wine is stored and capped by a closure assembly 12. It is well known in the art that the closure assembly 12 may be readily comprised of a sealed cork or twist off cap. During wine manufacturing and packaging, using the prior art bottle 10, the empty bottles 10 are ordered and arranged and passed though a series of automated handling devices typically comprising channels, guides and conveyors, all of which are specifically designed and sized to accommodate the standard 750 ml bottle size. The bottles 10 are initially ordered and arranged into a single line or multiple lines and passed to a fill station in which the product (wine) is filled into the bottle 10. Air is then evacuated from the bottle 10 and it is capped, or corked, and sealed, so that no air or gases can react with the wine stored therein. The filled bottle 10 is then packed for transportation, typically in multiple bottle cases, again specifically designed and sized for a typical 750 ml bottle, and distributed for retail sale to consumers at liquor stores and grocery stores, among others. The bottle of wine 10 may then be immediately consumed or it may be placed in a wine rack and stored and permitted to age by the consumer. It is a necessary consideration to packaging of wine for retail sales that most wine is packaged in 750 ml bottles and that most wine racks and storage facilities are built to accommodate that size and shape of bottle. It is a specifically contemplated benefit of the present invention that a portion of a bottle of wine may be opened and consumed, while leaving another portion unopened and protected, without affecting the ability of the remaining wine bottle to fit into packaging schemes, storage racks or shelves, at any of the manufacturing, retail or home storage facilities, designed for 750 ml bottles.

It is a significant disadvantage of prior art wine packaging and bottling that, as soon as a consumer opens the closure means and begins to consume the wine stored therein, the entire 750 ml stored therein is exposed to the outside air and gases and begins to spoil. The consumer is left with a finite time to consume the entire contents (750 ml) of the bottle of wine under optimum conditions, e.g. with robust flavor and without any of the effects of reaction with outside gases. If the entire contents are not consumed, even if the closure assembly 12 is re-applied, air and gases have been introduced into the bottle 10, the freshness of the wine has been compromised, and, often, the entire remaining contents will be disposed of by the consumer because of the loss of freshness.

The single bottle 10 of the prior art shown in FIG. 1 is comprised of a larger diameter lower section base 16 and smaller diameter upper section neck 18. The closure assembly 12 is shown in FIG. 1 provided by a cork 17 positioned in the neck opening 19, but prior art assemblies utilizing screw caps are specifically contemplated by the principles of the present invention.

In a first embodiment the present invention depicted at FIGS. 2, 2A comprises a combination bottle 20 having multiple receptacles 24, 26 for holding isolated fluids separately and independently from each other. The first receptacle 24 and second receptacle 26 combine to form a faux single bottle 20 that emulates in size and shape the typical 750 ml wine bottle disclosed in the prior art and depicted at FIG. 1.

The combination bottle 20, in the preferred embodiment of the present invention depicted at FIGS. 2, 2A, emulates the single 750 ml bottle depicted in FIG. 1 with the first receptacle 24 having a semicircular cross sectional base 28 and a semicircular cross sectional sleeve 30 (see FIGS. 2 2A and 4, 4A). The sleeve 30 comprises a cavity 32 accessible through a semicircular mouth 34. The outer radius of sleeve 30 is the same as the outer radius of the base 28, and the diameter of the combination base 28 and sleeve 30 is the same as the diameter of the base 16 of the typical 750 ml bottle shown in FIG. 1.

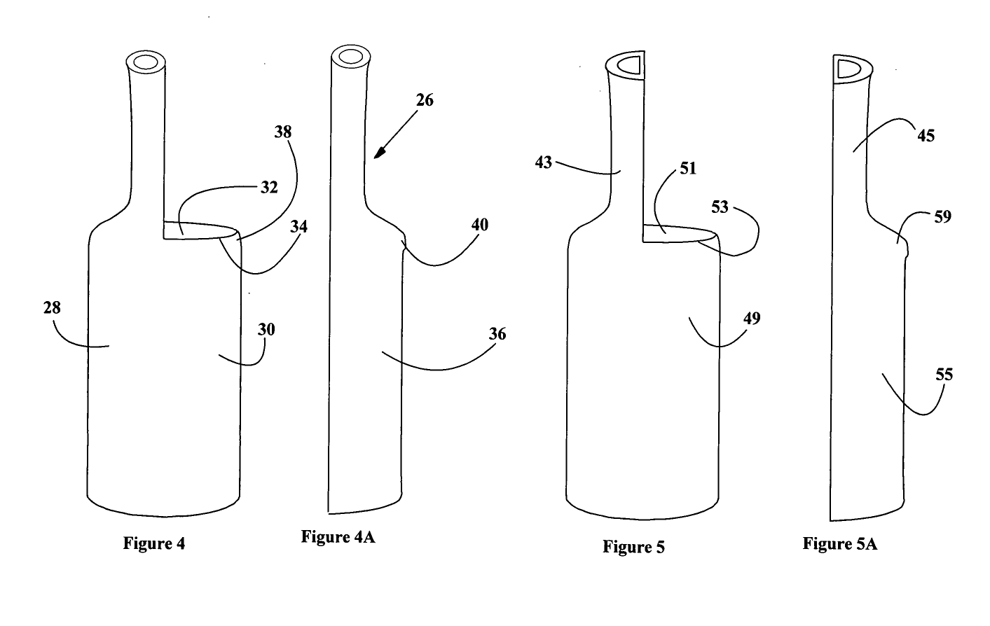

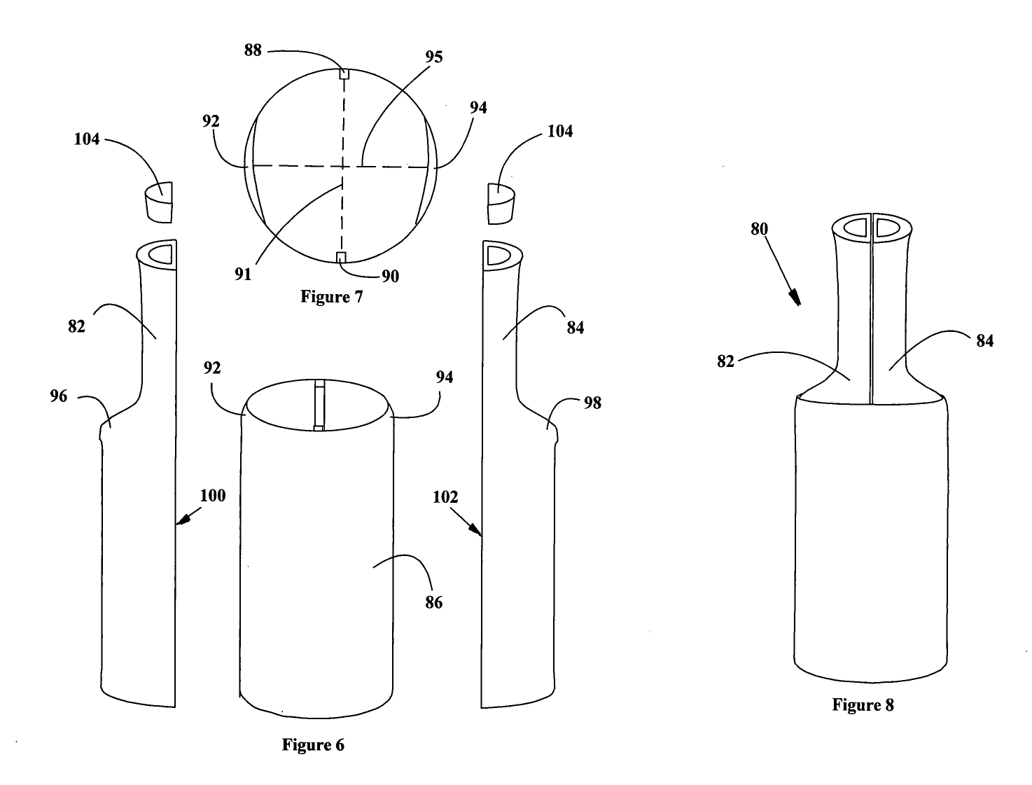

The second receptacle 26 has a semicircular cross section base 36 that is of a slightly smaller radius than that of the sleeve 30, thereby allowing the base 36 to fit into the mouth 34 of the sleeve 30 (see FIGS. 4 and 5).

In a significant feature of the present invention, the sleeve 30 is formed with a slight taper near its top edge 38 at the mouth 34. The second receptacle 26 has a raised shoulder 40 formed near the top of its base 36 that cooperates with the tapered top edge 38 to provide a means for locking the second receptacle 26 into the sleeve 30.

The shoulder 40 of the second receptacle 26 has a slightly greater radius than the radius of the tapered edge 38 so that an application of force on the second receptacle 26 will cause the resiliently deformable tapered edge 38 to be deformed to allow the shoulder 40 to pass through the tapered edge 38 and mouth 34, thereby locking the second receptacle 26 into the sleeve 30.

The combination bottle 20 of the present invention has a first receptacle 24 and a second receptacle 26 that are separable but which also may be locked together through locking means so that they can be transported, displayed and stored alongside bottles of wine in typical 750 ml bottles. The base of the combination bottle 20 is of the same shape and size as the base 16 of the prior art 750 ml bottle, and the combination bottle visually and spatially emulates the prior art 750 ml bottle to simplify manufacturing, handling, shipping and storage of the bottle 20.

The first embodiment of the present invention depicted at FIGS. 2, 2A and 4, 4A, comprises cylindrical necks 56, 58 and circular openings 60, 62 that are capped off by closure means 64, 66.

A second embodiment of the present invention illustrated in FIGS. 3, 3A and 5, 5A depicts a combination bottle 41 having a combination neck 42 emulating the neck 18 of the prior art 750 ml wine bottle 10 shown in FIG. 1. The neck 42 is made up of a semicircular neck 44 formed as part of the first receptacle 43 and a semicircular neck 46 formed as part of the second receptacle 45. Semicircular opening 48 formed in first receptacle 43 and a semicircular opening 50 formed in the second receptacle 45 are capped by individual semicircular closure devices 52, 54 (FIG. 3). In this second embodiment having semicircular necks 44, 46, the first receptacle 43 has a semicircular cross sectional base 49 (see FIGS. 3, 3A and 5, 5A). The sleeve 49 comprises a cavity 51 accessible through a semicircular mouth 53. The outer radius of sleeve 49 is the same as the outer radius of the base 47, and the diameter of the combination base 47 and sleeve 49 is the same as the diameter of the base 16 of the typical 750 ml bottle depicted in FIG. 1.

The second receptacle 45 has a semicircular cross section base 55 that is of a slightly smaller radius than that of the sleeve 49, thereby allowing the base 55 to fit into the mouth 53 of the sleeve 49 (see FIGS. 5 and 5A).

In a significant feature of the present invention, the sleeve 49 is formed with a slight taper near its top edge 57 at the mouth 53. The second receptacle 45 has a raised shoulder 59 formed near the top of its base 55 that cooperates with the tapered top edge 57 to provide a means for locking the second receptacle 45 into the sleeve 49.

The shoulder 59 of the second receptacle 45 has a slightly greater radius than the radius of the tapered edge 57 so that an application of force on the second receptacle 45 will cause the resiliently deformable tapered edge 57 to be deformed to allow the shoulder 59 to pass through the tapered edge 57 and mouth 53, thereby locking the second receptacle 45 into the sleeve 49.

The combination bottle 41 of the present invention thus has a first receptacle 43 and a second receptacle 45 that are separable but which also may be locked together through locking means so that they can be transported, displayed and stored alongside bottles of wine in typical 750 ml bottles. The base of the combination bottle 41 is of the same shape and size as the base 16 of the prior art 750 ml bottle and visually and spatially emulates such 750 ml bottle.

In a third embodiment of the present invention, a combination bottle 80 has multiple receptacles 82, 84 for holding isolated fluids separately and independently from each other. The first receptacle 82 and second receptacle 84, each comprising a receptacle shaped like half a wine bottle split diametrically along a vertical plane, are positioned in a base 86 to form a faux single bottle 80 (FIG. 8).

The receptacles 82, 84 are rigidly secured in the base 86 through the use of alignment tabs 88, 90 (FIG. 7) and a retention system comprising inwardly tapered edges 92, 94 formed on the base 86 and protruding shoulders 96, 98 formed on the receptacles 82, 84. The alignment tabs 88, 90 are diametrically opposed protrusions on the inner wall of the base 86 (FIG. 7). The tapered edges 92, 94 are diametrically opposed and depend inwardly at the top of the base 86. The diameter line 95 between the tapered edges 92, 94 is generally perpendicular to the diameter line 95 between the alignment tabs 88, 90 (FIG. 7). When assembled, the distal edges of the flat sides 100,102 of the receptacles 82, 84 engage the alignment tabs 88, 90 so that they are properly aligned to ensure that the raised shoulders 96, 98 engage the inwardly depending tapered edges 92, 94. In this way, the receptacles 82, 84 and base 86 form the wine bottle 80 that visually and spatially emulates a standard 750 ml wine bottle.

The wine bottle 80, having multiple receptacles 82, 84 may thus be shipped and stored in the same containers, racks and housings as other 750 ml wine bottles, while offering the flexibility benefits of multiple product packaging or partial consumption that maintains a remaining portion in its sealed state.

In all three embodiments, closure means 52, 54, 64, 66, 104, 106 are preferably provided by corks appropriately sized and shaped to fit the corresponding openings. However, other closure devices such as screw caps and press on caps are specifically contemplated and do not depart from the principles of the present invention.

In the three preferred embodiments of the present invention discussed herein, the receptacles 24, 26, 43, 45, 82, 84 and base 86 are formed from moldable plastic to make them lightweight and efficient. The receptacles 24, 26, 43, 45, 82, 84 are interiorly coated with a thin sheet of a non-reactive polymer to prevent any reaction or ill effects on the wine stored therein. Also, the receptacles 24, 26, 43, 45, 82, 84 and base 86, are formed from plastic sufficiently flexible and resilient to allow both the raised shoulders 40, 59, 96, 98 and tapered edges 38, 57, 92, 94 have the requisite deformability to allow the receptacles 26, 45, 82, 84 to be securely locked into the sleeves 30, 49 or base 86.

A method for packaging wine is also provided in the present invention which comprises the first step of providing a combination wine bottle 20, 41, 80 as described herein having a first receptacle 24, 43, 82 and a second receptacle 26,45, 84. Next, in the manufacturing and bottling of the wine is provided the step of filling each of the two receptacles with the same wine. Next, the two receptacles 24, 26 are evacuated, closed and sealed with independent closure devices to provide a dual package wherein only half of the wine is accessed by opening one of the two independent closure devices, leaving the other to be maintained fresh and, if desired, permitted to age by the consumer.

A method for packaging wine is also provided wherein the first step is providing a combination wine bottle 80 as described herein having a first receptacle 82 and a second receptacle 84. Next, in the manufacturing and bottling of the wine is provided the step of filling each of the two receptacles with different wines. Next, the two receptacles 82, 84 are evacuated, closed and sealed with independent closure devices to provide a dual package wherein either of the two different wines may be accessed by opening one of the two independent closure devices.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. A combination bottle having multiple separate compartments comprising:
a first receptacle;
a sleeve affixed to said first receptacle;
a second receptacle separable from said first receptacle;
independent closure means on said first receptacle and said second receptacle;
means for locking said second receptacle in said sleeve;
wherein a combination of said second receptacle retained in said sleeve affixed to said first receptacle is the size and shape of a typical wine bottle.

2. The combination bottle set forth in claim 1 wherein said typical wine bottle comprises a 750 milliliter wine bottle.

3. The combination bottle set forth in claim 3 wherein said first receptacle, said second receptacle and said sleeve are formed from resilient, deformable plastic.

4. The combination bottle set forth in claim 3 wherein said means for locking comprises a raised shoulder formed on said second receptacle correspondingly engaging a tapered mouth formed in said sleeve.

5. A method for packaging wine comprising the steps of:
providing a combination bottle emulating a single bottle of wine in size and shape, the combination bottle having multiple receptacles, each of said receptacles having independent means for closure;
filling and sealing each of said multiple receptacles with wine such that a consumer can consume the wine packaged in one receptacle without accessing the wine packaged in the other receptacle.

6. The method as set forth in claim 5 wherein the same wine is packaged in each of said receptacles.

7. The method as set forth in claim 5 wherein different wines are packaged in each of said receptacles.

8. A combination bottle having multiple separate compartments comprising:
a first receptacle;
a second receptacle separable from said first receptacle;
a base receiving each of said first receptacle and said second receptacle;
independent closure means on said first receptacle and said second receptacle;
a retention system for securing said first receptacle and said second receptacle within said base;
means for properly aligning said first receptacle and said second receptacle within said base to engage said retention means;
wherein a combination of said second receptacle retained in said sleeve affixed to said first receptacle is the size and shape of a typical wine bottle.
